(19) United States
(12) Patent Application Publication
(10) Pub. No.: US 2007/0172310 A1
(43) Pub. Date: Jul. 26, 2007

(54) Rotary spindle structure

(75) Inventors: Sheng-Hsiung Yang, Hsinchu County (TW); Mu-Kun Hsueh, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SmartAnt Telecom Co., Ltd., Jhudong Township (TW)

(21) Appl. No.: 11/655,652

(22) Filed: Jan. 19, 2007

(30) Foreign Application Priority Data
Jan. 20, 2006 (TW) 095201391

(51) Int. Cl. F16J 1/16

(52) U.S. Cl. 403/150

(57) ABSTRACT

A rotary spindle structure applied in a housing is provided, which includes two spindle lugs having a suspended resilient butt joint respectively. When a spindle rod is fit in the spindle lugs, both end faces of the spindle rod bear against the resilient butt joints, so that the resilient butt joints are forced to expand outwards till a pivot hole of the spindle rod is snapped with protruding walls of the spindle lugs, and thus, the spindle rod is freely rotationally connected to the spindle lugs. Furthermore, a pair of reinforcing pads is used to bear against the resilient butt joints to enhance the joining strength between the spindle lugs and the spindle rod.

### CROSS-REFERENCE TO RELATED APPLICATIONS

This non-provisional application claims priority under 35 U.S.C. § 119(a) on Patent Application No(s). 095201391 filed in Taiwan, R.O.C. on Jan. 20, 2006, the entire contents of which are hereby incorporated by reference.

### BACKGROUND OF THE INVENTION

1. Field of Invention

The present invention relates to a rotary spindle structure, and more particularly to a rotary spindle structure, which is easily assembled and disassembled, and not easily deformed.

2. Related Art

Concerning portable electronic products in the current market, due to the rapid development of electronic science and technology, wireless communication has become the mainstream of the current electronic industry, in order to transmit and exchange information more rapidly and efficiently. A directional antenna for receiving wireless signals becomes an important electronic device. In order to receive more signals with more complete contents, the antenna is designed to be capable of swinging freely, such that a user can randomly adjust the direction and tilt angle of the antenna, so as to improve the efficiency of the antenna in receiving signals.

In Taiwan Patent No. M266562 disclosed “Pivotal Body Buckling Structure with Positioning Adjustability”, and Taiwan Patent No. No. M282472 disclosed “Gyrating Structure of Rotation spindle”, an adjustable rotation spindle is disclosed to be applied in various products required to be rotated and enfolded, and some elements such as a resilient element, a snap ring, and a protruding rib of the body of the rotation spindle, are used for fixing and snapping the rotation spindle.

However, the component elements for a conventional spindle structure are so complex that the assembling steps and the manufacturing time are increased, which results in a high cost. Furthermore, in most cases, the rotary spindle structure is made of plastic and cannot be easily assembled and disassembled because of the poor material strength, and the rotary spindle structure will suffer from plastic deformation after a long time use, which causes the changing of the size, thereby affecting the service life. On the contrary, if the material strength of the rotary spindle structure is enhanced, the user will find that it is difficult to assemble and disassemble the rotary spindle structure and the rotary spindle structure is usually damaged due to inappropriately exerting a force. Additionally, in order to facilitate the installation, the contact area of the spindle lugs is increased accordingly, and thus, the spindle lugs become higher, which not only occupies a larger space, but also causes a poorer appearance and a higher manufacturing cost.

### SUMMARY OF THE INVENTION

In view of the aforementioned problems, the present invention provides a rotary spindle structure, so as to eliminate the limitations or disadvantages in the prior art that the material strength and the convenience in installation cannot be considered at the same time.

The present invention provides a rotary spindle structure, which is applied in a housing. A pair of suspended resilient butt joints is disposed on a pair of spindle lugs of the rotary spindle structure, and a spindle rod is pivotally fit in the spindle lugs. When the spindle rod is fit in the spindle lugs, both end faces of the spindle rod bear against the resilient butt joints to force the resilient butt joints to expand outwards till pivot holes of the spindle rod are snapped with protruding walls of the spindle lugs, and thus, the spindle rod is freely rotationally connected to the spindle lugs. The resilient butt joints enable the user to easily fit the spindle rod in the spindle lugs, without exerting excessive forces.

Additionally, a pair of reinforcing pads is disposed on the side of the housing opposite to the side where the spindle lugs are disposed, and bears against one side of the resilient butt joints. The joining strength between the spindle slugs and the spindle rod can be enhanced through using a pad instead of other complicated elements. Thus, the aims of elegant appearance and cost-effectiveness can be both achieved without increasing the height of the spindle lugs.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is an exploded schematic view of the present invention;

FIG. 1B is a schematic isometric view of the present invention;

FIG. 2A is an exploded schematic view of another embodiment of the present invention;

FIG. 2B is a schematic isometric view of another embodiment of the present invention; and

FIG. 2C is a partially enlarged view of another embodiment of the present invention.

### DETAILED DESCRIPTION OF THE INVENTION

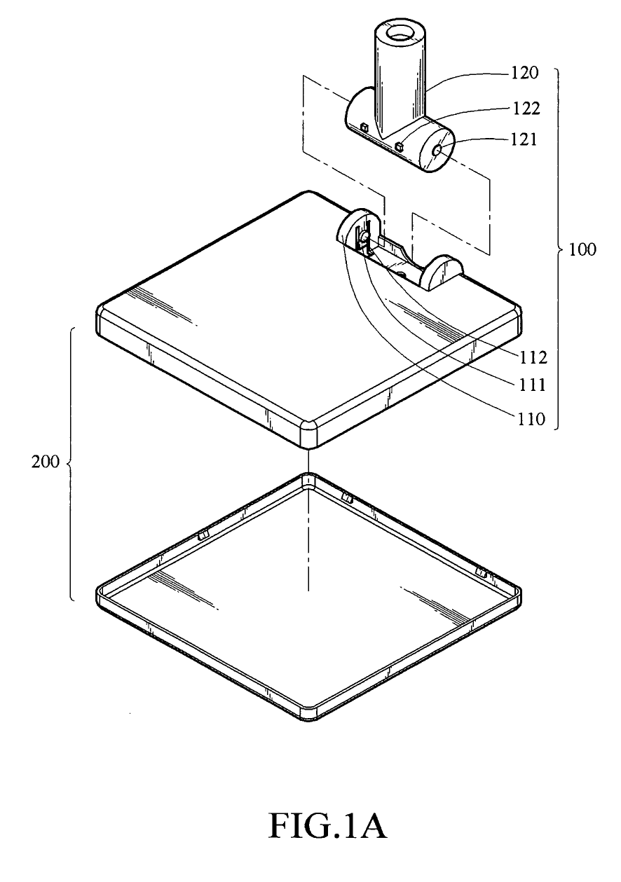

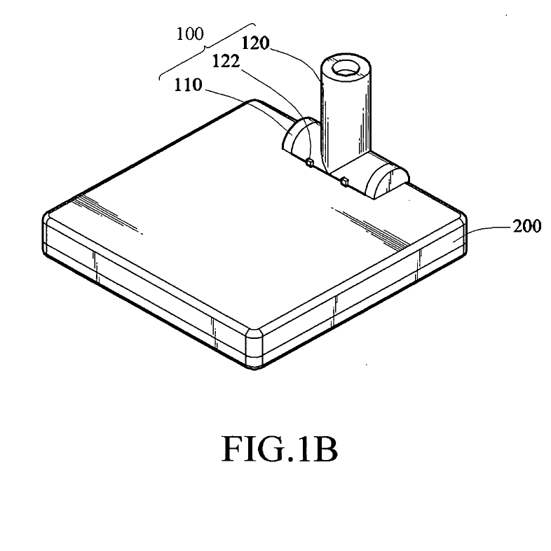

Refer to FIGS. 1A and 1B, the present invention provides a rotary spindle structure 100, which is applied in a housing 200. The rotary spindle structure 100 has a pair of spindle lugs 110 and a spindle rod 120. The spindle lugs 110 are disposed oppositely on one side of the housing 200 and spaced apart by a distance, and each of the spindle lugs 110 has a suspended resilient butt joint 111 with a corresponding protruding wall 112 respectively. The spindle rod 120 is just pivotally fit in the spindle lugs 110 and has two end faces, which are opposite to each other and have a corresponding pivot hole 121 respectively. When the spindle rod 120 is fit in the two spindle lugs 110, the two end faces of the spindle rod 120 bear against the resilient butt joints 111, so that the two resilient butt joints 111 are forced to expand outwards till their protruding walls 112 are snapped with the pivot holes 121 of the spindle rod 120, and thus, the spindle rod 120 is freely rotationally connected to the spindle lugs 110.

As shown in FIG. 1B, the spindle rod 120 further has at least one stopper 122 to limit the rotation of the spindle rod 120 within a specific range.

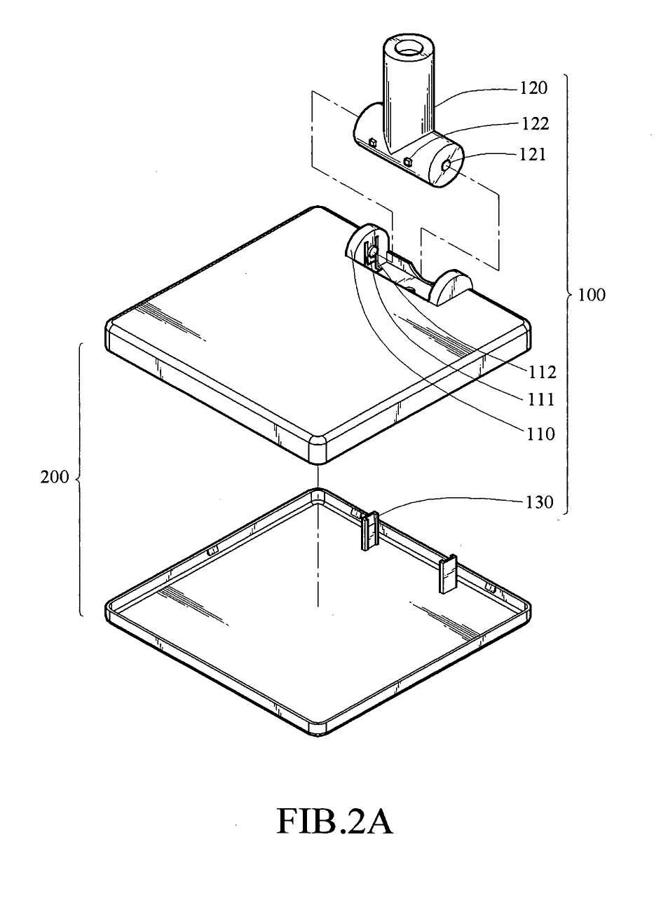

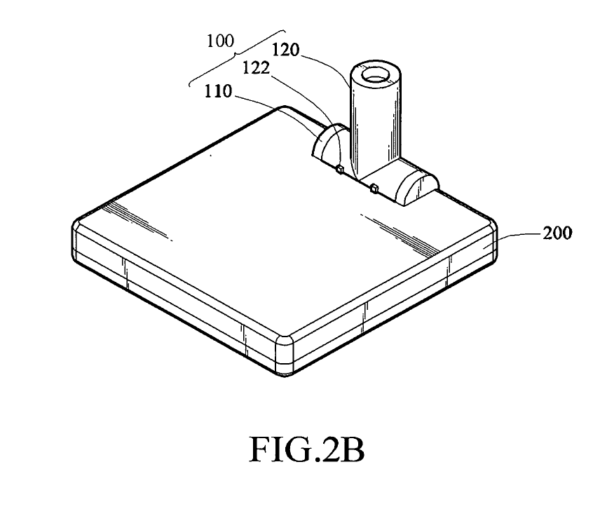

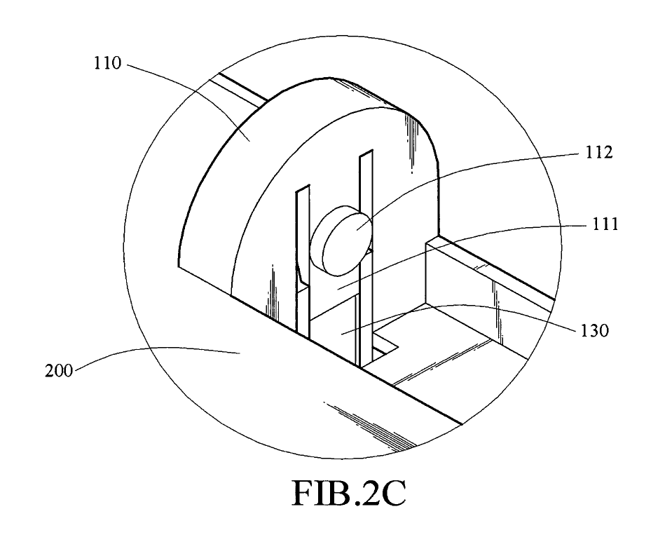

Please refer to FIG. 2A, FIG. 2B, and FIG. 2C, another embodiment of the present invention mainly provides a rotary spindle structure 100, which is applied in a housing 200. The rotary spindle structure 100 has a pair of spindle lugs 110, a spindle rod 120, and a pair of reinforcing pads 130. The spindle lugs 110 are disposed oppositely on one side of the housing 200 and spaced apart by a distance, and each of the spindle lugs 110 has a suspended resilient butt joint 111 with a corresponding protruding wall 112 respectively. The spindle rod 120 is just pivotally fit in the spindle lugs 110 and has two end faces, which are opposite to each other and have a corresponding pivot hole 121 respectively. When the spindle rod 120 is fit in the spindle lugs 110, the two end faces of the spindle rod 120 bear against the resilient butt joints 111, so that the two resilient butt joints 111 are forced to expand outwards till their protruding walls 112 are snapped with the pivot holes 121 of the spindle rod 120, and thus the spindle rod 120 is freely rotationally connected to the spindle lugs 110. The reinforcing pads 130 are disposed on one side of the housing 200 opposite to the side where the spindle lugs 110 are disposed, and bear against one side of the resilient butt joints 111, so as to enhance the joining strength between the spindle lugs 110 and the spindle rod 120.

As shown in FIG. 2B, the spindle rod 120 further has a stopper 122 to limit the rotation of the spindle rod 120 within a specific range. Additionally, the contact surface for the reinforcing pads 130 to bear against the resilient butt joints 111 is a ramp.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rotary spindle structure, applied in a housing, comprising:
a pair of spindle lugs, each of said spindle lugs oppositely disposed on one side of the housing, spaced apart by a distance, and having a suspended resilient butt joint with a protruding wall respectively; and
a spindle rod, pivotally fit in said spindle lugs, wherein said spindle rod has two end faces that are opposite to each other and have a pivot hole respectively, and when said spindle rod is fit in said spindle lugs, the two end faces bear against the resilient butt joints, so that the resilient butt joints are forced to expand outwards till the protruding walls and the pivot holes are snapped with each other, and thus, said spindle rod is freely rotationally connected to said spindle lugs.

2. The rotary spindle structure as claimed in claim 1, wherein said spindle rod has at least one stopper for limiting the rotation of said spindle rod within a specific range.

3. A rotary spindle structure, applied in a housing, comprising:
a pair of spindle lugs, oppositely disposed on one side of the housing, spaced apart by a distance, and each having a suspended resilient butt with a protruding wall respectively;
a spindle rod, pivotally fit in said spindle lugs, wherein said spindle rod has two end faces that are opposite to each other and have a pivot hole respectively, and when said spindle rod is fit in said spindle lugs, the two end faces bear against the resilient butt joints, so that the resilient butt joints are forced to expand outwards till the protruding walls and the pivot holes are snapped with each other, and thus, said spindle rod is freely rotationally connected to said spindle lugs; and
a pair of reinforcing pads, disposed on the side of the housing opposite to the side where said spindle lugs are disposed, and used for bearing against one side of the resilient butt joints.

4. The rotary spindle structure as claimed in claim 3, wherein said spindle rod has at least one stopper for limiting the rotation of said spindle rod within a specific range.

5. The rotary spindle structure as claimed in claim 3, wherein a contact surface for the reinforcing pads to bear against the resilient butt joints is a ramp.
